(19) United States
(12) Patent Application Publication
(10) Pub. No.: US 2014/0260871 A1
(43) Pub. Date: Sep. 18, 2014

(54) Fish Chunking Apparatus

(71) Applicants: Richard S. Constantine, Milford, CT (US); Man For Ma, New Territories (HK)

(72) Inventors: Richard S. Constantine, Milford, CT (US); Man For Ma, New Territories (HK)

(21) Appl. No.: 13/834,660

(22) Filed: Mar. 15, 2013

(51) Int. Cl. A01K 97/04; B26D 3/18; B26D 1/03

(52) U.S. Cl. CPC A01K 97/045; B26D 1/03; B26D 3/18
USPC 83/567; 83/569

(57) ABSTRACT

A fish chunking apparatus comprises a base assembly, a handle assembly, a plurality of blades, and a pressing assembly. The base assembly defines a discharge opening. The handle assembly is pivotally mounted to the base, while the blades are disposed across the base and define interstitial spaces. The pressing assembly has a first end connected to the handle assembly and a second end pivotally mounted to the base. A fish received on the blades is chunked into a plurality of sections upon pivotally manipulating the handle assembly such that the pressing assembly forces the fish against the blades until the pressing assembly is received in the interstitial spaces.

### BACKGROUND OF THE DISCLOSURE

The present disclosure relates to apparatus for chunking fish, and, in particular, to an apparatus for chunking fish employing a handle assembly pivotally mounted to a base.

Sportsmen and commercial line fishermen traditionally jettison chum into the water to attract larger game fish to hooks baited with smaller fish. A filet knife is traditionally used in the process of separating a fish into a number of chunks for use either as bait or chum. An effective filet knife must be extremely sharp to provide clean, consistent cuts through the flesh of the fish, however. A sportsman must be cautious when chunking baitfish, as the knife may slip in his grasp or injure another fisherman if used carelessly in choppy conditions.

Fish chunking devices are utilized on commercial and sport fishing boats to simplify the process of separating fish into chunks. U.S. Pat. Nos. 5,562,533 and 6,558,244 are illustrative of apparatus for chunking fish known in the art. Traditionally, fish chunking apparatus comprise a base having sidewalls which define a cavity. A blade assembly traditionally extends between sidewalls of the base forming the cavity. A press plate or lever arm is hingeably attached to the base and is configured on the base such that fish placed on top of the blades are pushed against and past the blade assembly.

These devices provide an advantage over traditional methods of chunking a fish with a knife, in that the fish may be chunked more quickly. Notwithstanding, when non-frozen fish are chunked, prior art fish chunking apparatus may still crush the flesh of the fish in the process, providing raggedly cut chunks.

There is a need for an improved fish chunking device which efficiently produces clean cuts through the flesh of a baitfish, while obviating the need for a sharpened filet knife.

### SUMMARY

Briefly stated, a fish chunking apparatus according to the current disclosure comprises a base, a handle assembly, a pressing assembly, and a plurality of blades. The base defines a discharge opening, while the plurality of blades are arranged across the opening so as to define interstitial spaces. The handle assembly is pivotally mounted to the base, and a first end of the pressing assembly is connected to the handle assembly. A second end of the pressing assembly is pivotally mounted to the base.

A fish received on the plurality of blades is chunked into a plurality of sections by pivotally manipulating the handle assembly until the pressing assembly contacts the fish. Upon further pivotally manipulating the handle assembly, the pressing assembly forces the fish against and past the blades, while simultaneously forcing the fish through the interstitial spaces defined by the blades. The blades progressively sever the skin, bones and muscle of the fish until the pressing assembly is received in the interstitial spaces, at which point a plurality of individual severed chunks fall through the discharge opening.

According to one embodiment of the current disclosure, the handle assembly has parallel sidewalls and first and second ends. The handle assembly is pivotally mounted to the base at the handle assembly first end, while a handgrip transverse to the sidewalls is located at the handle assembly second end. The pressing assembly is pivotally connected to the handle assembly at a pressing assembly first end. The pivotal connection between the handle and pressing assemblies is located intermediate the handle assembly first and second ends.

In accordance with a further aspect of the disclosure, the pressing assembly comprises a plurality of parallel pressing arms. Each arm is sized to be received in the interstitial spaces defined by the blades. Each of the arms is pivotally connected to the handle assembly via an articulated connection. The articulated connection comprises a plurality of links each pivotally connected at a link first end to the pressing assembly first end and pivotally connected at a link second end to the handle assembly.

In accordance with a further aspect of the disclosure, each of the plurality of blades may be disposed within the base at a different height. The blades may be staggered within the base such that they are aligned on an angle. When the blades are configured thus, a fish received on the blades is inclined with respect to a plane defined by a top surface of the base.

The fish chunking apparatus of the current disclosure provides a precise cut for each chunked section of a baitfish without crushing the soft body of non-frozen fish. The fish chunking apparatus is quicker than chunking baitfish with a filet knife, and eliminates the risk of injury in rough or choppy waters.

The fish chunking apparatus of the current disclosure was designed to chunk baitfish such as mackerel, menhaden, and mullet. One of ordinary skill in the art will appreciate that the dimensions of the apparatus described herein may be modified for use with larger fish or for applications beyond fish chunking.

### BRIEF DESCRIPTION OF THE DRAWINGS

Aspects of the preferred embodiment will be described in reference to the Drawing, wherein like numerals reflect like elements:

FIG. 1 shows a perspective view, partially in phantom, of a fish chunking apparatus;

FIG. 2 shows a side view, partially in phantom, of the fish chunking apparatus of FIG. 1;

FIG. 3 shows a top plan view of the fish chunking apparatus of FIG. 1;

FIG. 4 shows a cross-sectional view of one embodiment of the fish chunking apparatus, the section being taken in a plane perpendicular to the plurality of blades;

FIG. 5 shows a cross sectional view of one embodiment of the fish chunking apparatus; the section being taken in a plane parallel with the plurality of blades; and

FIG. 6 shows a perspective view of the embodiment of the fish chunking apparatus of FIG. 5 wherein the pressing assembly and handle assembly are raised, and one of the plurality of blades is pivoted in the unlocked position for the purpose of clarity.

### DETAILED DESCRIPTION

With reference to the drawing wherein like numerals represent like parts throughout FIGS. 1-6, a fish chunking apparatus is generally designated by the numeral 10.

As shown in FIG. 1, the fish chunking apparatus 10 generally comprises a base 12, a handle assembly 14, a pressing assembly 16, and a plurality of blades 18. Though the fish chunking apparatus 10 of the present disclosure is described in connection with separating baitfish into a plurality of chunks for use in sport fishing, one of ordinary skill will appreciate that the dimensions of the apparatus described may be altered to utilize the device with fish of any size.

Referring to FIGS. 1 and 2, the base 12 defines a discharge opening 60 through which sections of fish drop after they are chunked by the fish chunking apparatus 10. The handle assembly 14 is pivotally mounted to the base 12 at a handle assembly first end 20. Generally parallel sidewalls 22 extend between the handle assembly first end 20 and a handle assembly second end 24. A hand grip 26 is configured at the handle assembly second end 24, extending transversely between the handle assembly sidewalls 22.

A first end 30 of the pressing assembly 16 is connected to the handle assembly 14 intermediate the handle assembly first and second ends 20 and 24. The pressing assembly 16 is pivotally mounted to the base at a pressing assembly second end 32. As shown in FIGS. 1 and 2, the pressing assembly second end 32 is pivotally mounted to the base 12 adjacent the pivotal mount between the handle assembly 14 and the base 12.

In one embodiment best seen in FIGS. 1 and 2, an articulated connection comprising a plurality of links 34 provides a pivotal connection between the pressing assembly first end 30 and the handle assembly 14. Link first ends 36 are pivotally connected to the pressing assembly first end 30, while link second ends 38 are connected to the handle assembly 14 intermediate the handle assembly first and second ends 20 and 24. As best seen in FIG. 1, the link second ends 38 may be connected to the handle assembly 14 by an axle 40 extending between the sidewalls 22.

As best seen in FIGS. 1, 3 and 4, the pressing assembly may comprise a plurality of parallel pressing arms 42. The arms 42 are sized to be received in interstitial spaces 44 defined intermediate each of the plurality of blades 18. Arcuate fingers 46 may project from each of the arms 42 at the pressing assembly first end 30. Fish secrete a glycoprotein that protects their scales from bacterial infection, but which makes the fish slippery out of water. The fingers 46 are configured and positioned to ensure that the slippery glycoprotein coat does not affect the quality of the cut when chunking the baitfish.

The fingers 46 retain a baitfish (not shown) and cooperate with the pressing assembly 16 to force the baitfish against the plurality of blades 18. Not only do the fingers 46 prevent the fish from slipping off the blades 18, but also ensure that a baitfish is gradually pushed against and past the blades 18 along a dorsoventral axis of the fish. The progressive pressure on the body of the baitfish from dorsal to ventral side, or vice versa, prevents the pressing assembly 16 from squishing the body of the baitfish as the baitfish is chunked. Should the glycoprotein cause the fish to slide along the blades 18, the fingers 46 retain the dorsal/ventral side of the fish. Once the fingers 46 retain the fish and prevent further slippage, the pressing assembly 16 pivotably forces the fish against the blades 18, gradually chunking the fish from the dorsal to ventral side, or vice versa.

FIG. 4 shows an alternate embodiment, where each of the plurality of blades 18 is staggered with respect to one another. The blades 18 are each staggered within the base 12 such that each blade 18 is configured at a different height. In the embodiment shown in FIG. 4, the blades 18 are arranged linearly and at an angle. In this embodiment, a fish that is received on the blades is inclined with respect to a plane defined by a top surface 48 of the base 12. Chunking the fish from anterior to posterior end, or vice versa, has also shown to prevent the pressing assembly 16 from squishing the body of the fish.

The blades 18 are angled so that when the baitfish is chunked, the resultant chunks have an angled configuration so they tend to spin when thrown into the water. The reason for this is so the silver belly of the bait chunks rotate as they descend and the reflection attracts fish.

In an alternate embodiment to the arrangement depicted in FIG. 4 (not shown), each link has a progressively longer length than one neighboring link 34. Configured thus, the individual pressing assembly arms 42 are linearly staggered with respect to one another such that the pressing assembly arms 42 are aligned at an angle with respect to a plane defined by the top surface of the base 48. The blades 18 are arranged to define a plane parallel with the plane defined by the top surface of the base 48. Similar to the embodiment shown in FIG. 4, the staggered arrangement of the pressing assembly arms 42 progressively chunks the fish from the anterior end to the posterior end, or vice versa.

In one embodiment shown in FIGS. 5 and 6, each of the plurality of blades 18 is pivotally mounted within the base 12. Each of the blades 18 is transformable from a locked position (FIG. 5) to an unlocked position (FIG. 6). Each of the blades has a first and second end, 68 and 70, respectively. As shown in FIGS. 5 and 6, the first end 68 provides a pivotal connection 54, which may be implemented by a simple U-shaped connection. When installed in the locked position, the blade first end engages a pivot rod 72 which defines a blade retention axis A-A located adjacent the pressing assembly second end 32. Each blade 18 is pivotable about the blade retention axis A-A between the locked and unlocked positions.

As shown in FIGS. 5 and 6, each blade second end 70 has a snap fit connector 50 which engages a cavity 52 defined in the base 12 configured to receive the snap fit connector 50. In the embodiment shown in FIGS. 5 and 6, the snap fit connector 50 is a cantilevered snap fit connector. As best seen in FIGS. 2 and 5, a block 56 and a retaining ledge 58 define each of the cavities 52.

Referring to FIGS. 1, 2, 5, and 6 a bottom portion of the base 62 is configured such that the base 12 is receivable in a mouth of a bucket (not shown). As depicted, the bottom portion 62 is a circular portion of material which projects below a bottom surface 64 of the base, and which is recessed from exterior sides 66 of the base 12. The shape of the bottom portion 62 may be adapted to fit buckets having a plurality of other cross-sectional shapes.

While a preferred embodiment has been set forth for purposes of illustration, the foregoing description should not be deemed a limitation of the invention herein. Accordingly, various modifications, adaptations and alternatives may occur to one skilled in the art without departing from the spirit of the invention and the scope of the claimed coverage.

1. A fish chunking apparatus comprising:
a base assembly defining a discharge opening;
a handle assembly pivotally mounted to said base;
a plurality of blades disposed across said opening and defining interstitial spaces;
a pressing assembly having a first end connected to said handle assembly and a second end pivotally mounted to said base;
wherein a fish received on said plurality of blades is chunked into a plurality of sections upon pivotally manipulating said handle assembly such that said pressing assembly forces said fish against said blades until said pressing assembly is received in said interstitial spaces.

2. The fish chunking apparatus of claim 1, wherein said pressing assembly comprises a plurality of generally parallel pressing arms, each arm sized to be received in said interstitial spaces and pivotally connected to said handle assembly via an articulated connection comprising a plurality of links each connected at a connector link first end to said pressing assembly first end and at a connector link second end to said handle assembly intermediate handle assembly first and second ends.

3. The fish chunking apparatus of claim 2, wherein each of said arms has an arcuate finger projecting from said pressing assembly first end, configured to retain said fish and progressively force said fish against said blades when said handle assembly is pivotally manipulated.

4. The fish chunking apparatus of claim 2, wherein each of said links has a progressively longer length than an immediately neighboring link, such that each of said generally parallel fingers are linearly staggered with respect to one another, such that said pressing assembly fingers are aligned at an angle with respect to a top surface of said base, and wherein said blades are arranged parallel to one another, such that said blades define a cutting surface parallel with a plane defined by said top surface.

5. The fish chunking apparatus of claim 1, wherein each of said blades is staggered within the base with respect to each other, such that each of said blades is at a different height.

6. The fish chunking apparatus of claim 5, wherein said plurality of blades are generally aligned at an angle with respect to a plane defined by a top surface of said base such that blades disposed at opposite ends of said width are disposed at a highest and lowest most height within said base, wherein a fish received on said blades is inclined with respect to said plane.

7. The fish chunking apparatus of claim 1, wherein each of said plurality of blades has a first end engageable with a pivot rod configured adjacent said pressing assembly second end and defining a blade retention axis, and each of said blades is transformable between a locked position wherein said blade is secured within said base and an unlocked position wherein said blade is pivotable about said blade retention axis.

8. The fish chunking apparatus of claim 7, wherein each of said blades has a cantilevered snap fit connector at a blade second end located opposite said blade first end, and said base defines a plurality of cavities configured to receive said cantilevered snap fit connectors.

9. The fish chunking apparatus of claim 8, wherein a retaining ledge and a block adjacent a bottom surface of said base define each of said cavities.

10. The fish chunking apparatus of claim 1, wherein a bottom portion of said base is configured such that said base is receivable in a mouth of a bucket.

11. A fish chunking apparatus comprising:
a base assembly defining a discharge opening and having top and bottom surfaces;
a handle assembly having generally parallel sidewalls and first and second ends, said handle assembly pivotally mounted to said base at said handle assembly first end and having a handgrip transverse said sidewalls at said handle assembly second end;
a pressing assembly having a first end pivotally mounted to said handle assembly intermediate said handle assembly first and second ends and a second end pivotally mounted to said base;
a plurality of blades disposed across said opening and defining interstitial spaces;
wherein a fish received on said plurality of blades is chunked into a plurality of sections upon pivotally manipulating said handle assembly such that said pressing assembly forces said fish through said blades until said pressing assembly is received in said interstitial spaces.

12. The fish chunking apparatus of claim 11, wherein said pressing assembly comprises a plurality of generally parallel pressing arms, each arm sized to be received in said interstitial spaces and pivotally connected to said handle assembly via an articulated connection comprising a plurality of links each connected at a link first end to said pressing assembly second end and at a link second end to the handle assembly intermediate the handle assembly first and second ends.

13. The fish chunking apparatus of claim 12, wherein each of said pressing arms has an arcuate finger projecting from said pressing assembly first end, configured to retain said fish and force said fish against said blades when said handle assembly is pivotally manipulated.

14. The fish chunking apparatus of claim 12, wherein each of said links has a progressively longer length than an immediately neighboring link, such that each of said generally parallel arms are linearly staggered with respect to one another, such that said pressing assembly arms are aligned at an angle with respect to a plane defined by a top surface of said base, and wherein said blades are arranged parallel to one another, such that said blades define a cutting surface parallel with said plane.

15. The fish chunking apparatus of claim 11, wherein each of said blades is staggered within the base with respect to each other, such that each of said blades is at a different height.

16. The fish chunking apparatus of claim 15, wherein said plurality of blades are generally aligned at an angle with respect to a plane defined by a top surface of said base such that blades disposed at opposite ends of said width are disposed at a highest and lowest most height within said base, wherein a fish received on said blades is inclined with respect to said plane.

17. The fish chunking apparatus of claim 11, wherein each of said plurality of blades has a first end and engageable with a pivot rod configured adjacent said pressing assembly second end and defining a blade retention axis, and each of said blades is transformable between a locked position wherein said blade is secured within said base and an unlocked position wherein said blade is pivotable about said blade retention axis.

18. The fish chunking apparatus of claim 17, wherein each of said blades has a cantilevered snap fit connector at an end opposite said pivotal connection to said base, and said base defines a plurality of cavities configured to receive said cantilevered snap fit connectors.

19. The fish chunking apparatus of claim 18, wherein a retaining ledge and a block adjacent a bottom surface of said base define each of said cavities.

20. The fish chunking apparatus of claim 11, wherein said base has a bottom portion adjacent said bottom surface configured such that said base is receivable in a mouth of a bucket.
